(19) United States
(12) Patent Application Publication
(10) Pub. No.: US 2020/0218194 A1
(43) Pub. Date: Jul. 9, 2020

(54) IMAGE FORMING APPARATUS

(71) Applicant: KONICA MINOLTA, INC., Tokyo (JP)

(72) Inventor: Hiroyuki UI, Tokyo (JP)

(21) Appl. No.: 16/737,155

(22) Filed: Jan. 8, 2020

(30) Foreign Application Priority Data
Jan. 9, 2019 (JP) 2019-002128

(51) Int. Cl. G03G 21/00

(52) U.S. Cl. CPC G03G 21/0011

(57) ABSTRACT

An image forming apparatus includes a cleaning unit that includes a cleaning blade, a coating roller that comes in contact with an image carrier on an upstream side, in a conveyance direction, of the image carrier than the cleaning blade and coats toner onto the image carrier, and a plate member that comes in contact with the coating roller and coats toner onto the coating roller, and controls a contact force changer that changes a contact force of the plate member relative to the coating roller and/or a contact force of the coating roller relative to the image carrier, correspondingly to a change of an index with regard to the contact force of the coating roller.

### CROSS-REFERENCE TO RELATED APPLICATION

The present invention claims priority under 35 U.S.C. § 119 to Japanese patent application No. 2019-002128, filed on Jan. 9, 2019, the entire contents of which are incorporated herein by reference.

### BACKGROUND

### 1. Technical Field

The present invention relates to an image forming apparatus.

### 2. Description of Related Arts

In image forming apparatuses of an electrophotography system, a technique has been known that cleans an image carrier, such as an intermediate transfer belt and a photoconductor drum, with a cleaning blade (hereinafter, also simply referred to as a “blade”). In concrete terms, at a contact portion between the image carrier and the blade, an external additive released from toner is dammed up, whereby a stillness layer of the external additive is formed. Successively, toner is dammed up by the stillness layer, whereby the image carrier is cleaned.

Such a stillness layer also has a function to prevent the blade from being pulled and brought by the image carrier. In concrete terms, the external additive forming the stillness layer slightly slip through the contact portion between the image carrier and the blade, whereby the contact area between the image carrier and the blade decreases. As a result, the frictional force between the image carrier and the blade also decreases, whereby the blade is prevented from being pulled and brought by the image carrier.

However, in the case where an image of low coverage, an image whose position is biased or inclined in a vertical direction (for example, an axial direction of a photoconductor drum) relative to the conveyance direction of the image carrier, or the like is printed continuously, an amount of toner that reaches the blade, and hence, an amount of an external additive added to the toner, decreases. Accordingly, a stillness layer is depleted. In the case where the stillness layer is depleted, the blade is pulled excessively by the image carrier. Accordingly, cut surface wear (wear of a chamfered portion entering a cut surface side (an upstream side in the sliding direction) from an edge) of a blade may occur. Successively, in the case where printing is continued on the condition that the cut surface wear has occurred, the edge of the blade is worn away from the cut surface wear as a start point. Then, poor cleaning may occur. That is, in order to prevent poor cleaning, it is necessary to prevent the cut surface wear of a blade by supplying toner to the blade stably.

For such problems, Patent Literature 1 (JP 2005-275219A) discloses a technique that supplies toner retained by a plurality of members disposed on the upstream side of a blade to the blade by a roller. In this technique, the retained toner is made to adhere onto an image carrier by a van der Waals force acting between the toner and the image carrier and is conveyed by the image carrier, whereby the toner is supplied to the blade.

### SUMMARY

However, the van der Waals force changes due to temperature, humidity, the surface states of an image carrier, or the like easily. Therefore, in the technique disclosed by Patent Literature 1, there are problems that toner is not supplied to the blade stably and the cut surface wear of the blade is not prevented.

The present invention has been achieved in view of the above-mentioned problems. Accordingly, an object of the present invention is to provide an image forming apparatus that prevents the cut surface wear of a cleaning blade by supplying toner to the cleaning blade stably.

In order to realize the above-mentioned object, an image forming apparatus that reflects one aspect of the present invention, includes a cleaning unit that includes a cleaning blade that comes in contact with an image carrier and cleans the image carrier, a coating roller that comes in contact with the image carrier on an upstream side, in a conveyance direction, of the image carrier than the cleaning blade and coats toner onto the image carrier, and a plate member that comes in contact with the coating roller and coats the toner onto the coating roller; a contact force changer that changes a contact force of the plate member relative to the coating roller and/or a contact force of the coating roller relative to the image carrier; and a processor that controls the contact force changer correspondingly to a change of an index with regard to the contact force of the coating roller.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a drawing showing an outline of the whole configuration of an image forming apparatus according to a first embodiment.

FIG. 2 is an illustration showing a configuration of a cleaning unit.

FIG. 3 is a block diagram showing a hardware configuration of the image forming apparatus.

FIG. 4A is an illustration showing an example of a contact force changer.

FIG. 4B is an illustration showing an example of a contact force changer.

FIG. 5A is a schematic top view at an A-A line position in FIG. 4A.

FIG. 5B is an illustration showing a state where a support roller 81 has been moved to the left side.

FIG. 6 is a flowchart showing contact force stabilization processing.

FIG. 7A is a conceptual diagram showing an endurance change due to use of a coating roller and a change of a contact force with the endurance change in a comparative example.

FIG. 7B is a conceptual diagram showing an endurance change due to use of a coating roller 62 and a change of a contact force with the endurance change in the first embodiment.

FIG. 8A is an illustration showing a configuration of a cleaning unit in the second embodiment.

FIG. 8B is an illustration showing a configuration of a cleaning unit in the second embodiment.

FIG. 9 is an illustration showing a configuration of a cleaning unit in the third embodiment.

FIG. 10A is an illustration showing a configuration of a cleaning unit in the fourth embodiment.

FIG. 10B is an illustration showing a configuration of a cleaning unit in the fourth embodiment.

FIG. 11A is a time chart showing the transition of torque and the like at the time of starting in a comparative example.

FIG. 11B is a time chart showing the transition of torque and the like at the time of starting in the fifth embodiment.

### DETAILED DESCRIPTION OF EMBODIMENTS

Hereinafter, with reference to attached drawings, embodiments of the present invention will be described in detail. In this connection, in the description for the drawings, the same constitutional element is provided with the same reference symbol, and the overlapping description is omitted. Moreover, dimensional ratios in the drawings are exaggerated on account of description, and, may be different from the actual ratios.

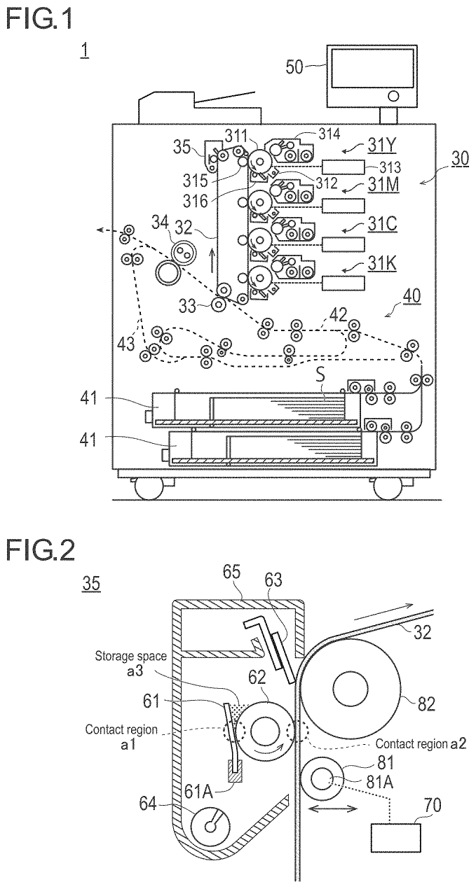

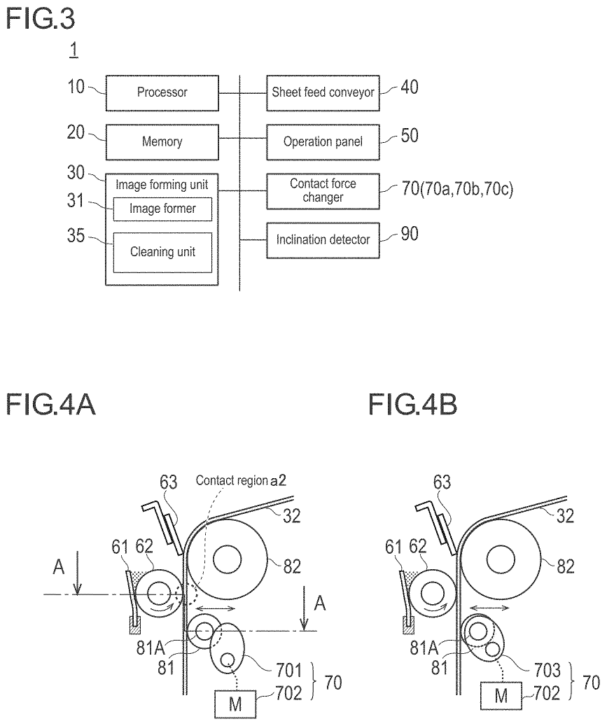

FIG. 1 is a drawing showing an outline of the whole configuration of an image forming apparatus according to a first embodiment of the present invention. FIG. 2 is a partial enlarged view of FIG. 1 and is an illustration showing a configuration of a periphery of a cleaning unit. FIG. 3 is a block diagram showing a hardware configuration of the image forming apparatus.

As shown in FIG. 1 to FIG. 3, an image forming apparatus 1 includes a processor 10, a memory 20, an image forming unit 30, a sheet feed conveyor 40, an operation panel 50, a contact force changer 70, and an inclination detector 90. As shown in FIG. 3, the image forming unit 30 includes an image former 31 and a cleaning unit 35.

The processor 10 is a CPU and performs control for each part of the apparatus and various kinds of arithmetic processing in accordance with a program. Moreover, the processor 10 has a timer function, controls an operation timing of each configuration part of the image forming apparatus 1, and records a use history, such as using time of each configuration part.

The memory 20 includes a ROM that stores various programs and various kinds of data beforehand, a RAM that memorizes a program and data temporarily as a work region, a hard disk that stores various programs and various kinds of data, and the like. The memory 20 records the use history of each configuration part of the image forming apparatus 1. The use history is, for example, a use history (using time, running time, running distance, or the number of used prints) of each of an intermediate transfer belt 32 and a coating roller 61 of the image forming unit 30.

(Image Forming Unit 30)

The image forming unit 30 includes a plurality of image formers 31Y, 31M, 31C, and 31K (hereinafter, these are collectively referred merely to as “image formers 31”) corresponding to respective basic colors of yellow (Y), magenta (M), cyan (C), and black (K). Moreover, the image forming unit 30 includes, in addition to the image formers 31, an intermediate transfer belt 32, a secondary transfer unit 33, a fixing unit 34, and a cleaning unit 35 for cleaning a belt.

(Image Former 31)

Each of the image formers 31 (31Y to 31K) includes a photoconductor drum 311, a charging electrode 312, an exposing unit 313, a developing unit 314, a primary transfer unit 315, and a cleaning unit 316 for cleaning the drum. Although the respective image formers 31 are different from each other in color of toner of a developer stored in the developer unit, they have the same configuration except the above matter.

The photoconductor drum 311 is an image carrier. The photoconductor drum 311 includes, for example, an organic photoreceptor in which a photosensitive layer including resin containing an organic photoconductor is formed on an outer peripheral surface of a drum-shaped metal base body and rotates counterclockwise as shown with an arrow in FIG. 1.

The charging electrode 312 is an electrode of a scorotron charger system and charges the surface of the photoconductor drum 311 to a constant potential. In this connection, as a system of the charging electrode 312, a corotron charger or a charging roller may be applied.

The exposing unit 313 includes a laser diode, a polygon mirror, a lens optical system, and the like, exposes the surface of the photoconductor drum 311 that is charged uniformly by the charging electrode 312, on the basis of image data, and forms an electrostatic latent image.

Each of the developing units 314 contains, as mentioned above, a two-component developer that includes at least a carrier particle and a toner particle of one color of different colors of yellow, magenta, cyan, and black and a small particle diameter. The two-component developer includes a carrier particle in which a ferrite particle is made a core and an insulating resin is coated around the ferrite particle and a toner particle in which polyester is made a main material, a colorant such as carbon black, and external additives, such as a charge control agent, silica, and titanium oxide are added into the main material. The carrier particle has a particle diameter of 15 to 100 μm and a saturation magnetization of 10 to 80 emu/g, and the toner particle has a particle diameter of 3 to 15 μm. The charging characteristic of the toner particle is a negative charging characteristic, and an average charge amount is −20 to −60 μC/g. As the two-component developer, one in which carrier particles and toner particles are mixed such that a toner concentration becomes 4 to 10 mass %, is used.

In the primary transfer unit 315, a foam roller, a solid roller, or the like each of which is made from NBR (Nitrile Butadiene Rubber) as a material, is used. The primary transfer unit 315 forms a transfer nip by coming in contact with the photoconductor drum 311. A voltage with a polarity opposite to the polarity (negative charge) of toner is applied to a rotation shaft of the primary transfer unit 315 by a voltage supplied from a power source (not shown) for transfer, whereby a toner image on the photoconductor drum 311 is transferred to the intermediate transfer belt 32.

Transfer residual toner remaining on the photoconductor drum 311 is removed by the cleaning unit 316 disposed on a downstream side. The cleaning unit 316 for cleaning a drum has a configuration similar to that of a later-mentioned cleaning unit 35 for cleaning the belt.

(Intermediate Transfer Belt 32)

The intermediate transfer belt 32 is rotatably stretched by a plurality of support rollers disposed on its inner peripheral surface. As shown with arrows in FIG. 1 and FIG. 2, the intermediate transfer belt 32 rotates in the clockwise direction. A driving force is transmitted to one or multiple rollers among the plurality of support rollers by a drive motor (not shown), thereby driving the intermediate transfer belt 32. As shown in FIG. 2, the plurality of support rollers includes support rollers 81 and 82 shown in FIG. 2. These support rollers 81 and 82 are also referred to as an opposing roller and a backup roller, respectively.

As the intermediate transfer belt 32, for example, used is a semiconductor belt made from polyimide as a material, in which volume resistivity is set to 8 to 11 LOG Ω·cm and a thickness is set to 80 μm. As mentioned above, a toner image formed by each of the image formers 31 is transferred by the primary transfer unit 315 in such a way that a full color toner image is formed on the intermediate transfer belt 32. The intermediate transfer belt 32 or the photoconductor drum 311 functions as an image carrier.

(Secondary Transfer Unit 33)

The secondary transfer unit 33 has a configuration similar to that of the primary transfer unit 315 and forms a transfer nip between itself and an opposing roller disposed on the inner peripheral surface side of the intermediate transfer belt 32. The toner images (full color) transferred so as to superimpose on each other on the intermediate transfer belt 32 are transferred onto a sheet S by the secondary transfer unit 33. On the other hand, transfer residual toner having remained on the intermediate transfer belt 32 is removed by the cleaning unit 35 disposed on a downstream side. The configuration of the cleaning unit 35 is mentioned later.

(Fixing Unit 34)

The fixing unit 34 includes a heating roller incorporating a heater therein and a pressing roller. The pressing roller comes in contact with the heating roller with a predetermined pressure so as to form a fixing nip therebetween, and a toner image transferred onto a sheet is conveyed into the fixing nip formed between the both rollers and is subjected to heating and pressing processing. With this, an image is formed on the sheet S.

(Cleaning Unit 35 for Cleaning Belt)

As shown in FIG. 2, the cleaning unit 35 includes a plate member 61, a coating roller 62, a cleaning blade 63 (hereinafter, merely referred to as a “blade 63”), a recovery screw 64, and a housing 65 that accommodates these components. Moreover, the cleaning unit 35 includes a contact force changer 70. In this connection, in the first embodiment, the plate member 61 and the coating roller 62 each shown below are disposed fixedly in the housing 65 by a support member (not shown) connected with the housing 65.

(Plate Member 61)

The plate member 61 is a plate-shaped member that comes in contact with the coating roller 62 and coats (applies) toner onto the coating roller 62. The plate member 61 is disposed so as to come in contact with the coating roller 62 with a predetermined contact force. As shown in FIG. 2, the plate member 61 comes in contact with the coating roller 62 on a first contact region a1 (contact by its non-edge portion (contact by its belly portion)). It is preferable that one end (upper end) of the plate member 61 is a free end and the other end (lower end) is a fixed end fixed to the holding member 61A.

It is preferable that the plate member 61 is a leaf spring material made of metal. This is because it is intended to avoid creep deformation of the plate member 61 that may be caused in the case where, for example, the plate member 61 is made of PET (polyethylene terephthalate) or non-leaf spring material and to ensure coatability of the plate member 61 relative to the coating roller 62. Examples of the material of the plate member 61 include stainless steel belts for springs, such as SUS301-CSP, SUS304-CSP, and SUS631-CSP. However, the materials are not limited to these. Moreover, in order to secure a contact force and followability relative to the coating roller 62 and to form a predetermined nip between itself and the coating roller 62, it is preferable that the plate member 61 has a thickness of 50 μm or more and less than 200 μm.

(Coating Roller 62)

The coating roller 62 is a roller-shaped member that rotates by coming in contact with the intermediate transfer belt 32 and coats toner coated by the plate member 61 onto the intermediate transfer belt 32. As shown in FIG. 2, the coating roller 62 comes in contact with the intermediate transfer belt 32 on a second contact region a2. The coating roller 62 rotates in the counterclockwise direction shown with an arrow in FIG. 2 by being driven with a drive motor (not shown). The coating roller 62 rotates at a predetermined speed in the with-direction (direction in which the surface moves in the same direction) relative to the conveyance direction of the intermediate transfer belt 32. In one example, the coating roller 62 rotates at a speed of a linear speed ratio of 0.45 relative to the intermediate transfer belt 32 in the with-direction relative to the conveyance direction of the intermediate transfer belt 32.

The coating roller 62 is disposed so as to press the intermediate transfer belt 32 with a predetermined pressing force. Moreover, the coating roller 62 is disposed so as to form a space (hereinafter, referred to as a “storage space”) to store toner at an upper portion (the direction opposite to the gravity direction) of a contact position (the first contact region a1) with the plate member 61. In a storage space a3 (shaded region in the drawing), storage toner is stored.

The capacity and position, relative to the blade 63, of the storage space a3 are set appropriately. For example, as shown in FIG. 2, in terms of the gravity direction, the upper surface of the storage space a3 is made lower than the tip (contact position) of the blade 63. Even in the case where toner is stored excessively, since the toner exceeds the plate member 61 (from the left side) and falls below, the surface of the stored toner does not arrive at the lower end of the blade 63. Accordingly, the occurrence of poor cleaning due to the excessively storing of toner, is prevented.

Moreover, an amount of toner coated onto the coating roller 62 by the plate member 61 is set to 5 g/m² or more and less than 50 g/m². Furthermore, an amount of toner that is coated onto the intermediate transfer belt 32 by the coating roller 62 and is supplied to the blade 63, is set to 0.5 g/m² or more and less than 4 g/m². According to an experiment, in the case where the contact force of the plate member 61 has been set to less than 5 N, an adhesion amount of toner supplied to the coating roller 62 has become less than 5 g/m², and, as a result, the cut surface wear of the blade 63 has occurred. On the other hand, in the case where the contact force of the plate member 61 has been set to 40 N or more, since an excessive amount of toner has been coated onto the coating roller by the plate member 61, an adhesion amount of toner on the coating roller has become 50 g/m² or more, and, as a result, poor cleaning has occurred.

In order to form a predetermine nip by the coating roller 62 on each of the contact regions a1 and a2 between the coating roller 62 and each of the plate member 61 and the intermediate transfer belt 32, it is preferable that the coating roller 62 includes an elastic layer. The reason is that, even in the case where the coating roller 62 inclines in an axial direction or has partial variations in an outside diameter, the inclination or the variations is absorbed by the elastic layer. In order to hold a sufficient amount of toner on the surface of the coating roller 62, it is preferable that the elastic layer is configured by a foam sponge.

In one embodiment, it is preferable that, in the foam sponge that constitutes the elastic layer of the coating roller 62, a cell diameter is 100 μm or more and 350 μm or less and a cell occupancy per unit area is 30% or more and less than 70%. In this connection, in the present embodiment, the cell occupancy rate per unit area means a value obtained by dividing the total value of the respective areas of cells existing in the unit area (1 mm×1 mm) on the surface of the coating roller 62 by the unit area. In one example, in the case where the cell diameter is set to 100 μm or more and 350 μm or less and the cell occupancy rate per unit area is set to 30% or more and less than 70%, toner of an amount necessary for preventing the cut surface wear of the blade 63 is held in the foam sponge.

On the other hand, in the case where the cell diameter is set to less than 100 μm and the cell occupancy rate per unit area is set to less than 30%, toner of an amount necessary for preventing the cut surface wear of the blade 63 is not held in the foam sponge.

Moreover, in the case where the cell diameter is set to larger than 350 μm, in the thickness direction of the foam sponge, the foam sponge becomes sparse (not dense). For this reason, by making the plate member 61 come in contact with the coating roller 62, or by pressing the coating roller 62 against the intermediate transfer belt 32, there may be a case where the foam sponge is shaved. In the case where the foam sponge has been shaved, the outside diameter of the coating roller 62 decreases, and a biting amount between the coating roller 62 and each of the plate member 61 and the intermediate transfer belt 32 also decreases. For this reason, in the foam sponge, toner of an amount necessary for preventing the cut surface wear of the blade 63 is not held.

Moreover, in the case where the cell occupancy rate per unit area is set to 80% or more, the area of a contact surface between the non-cell portion of the coating roller 62 and each of the plate member 61 and the intermediate transfer belt 32 decreases. For this reason, the contact force of the plate member 61 relative to the coating roller 62 and the pressing force of the coating roller 62 relative to the intermediate transfer belt 32 concentrate to the non-cell portion, whereby there may be a case where a cell skeleton is broken into pieces. In the case where the cell skeleton is broken into pieces, since the volume of a foam sponge decreases, toner of an amount necessary for preventing the cut surface wear of the blade 63 is not held in the foam sponge.

(Setting of Contact Force and Pressing Force)

An amount of toner coated onto the coating roller 62 by the plate member 61 is controlled by the contact force (hereinafter, also merely referred to as a “contact force”) of the plate member 61 relative to the coating roller 62. Moreover, an amount of toner that is coated onto the intermediate transfer belt 32 by the coating roller 62 and is supplied to the blade 63, is controlled by the pressing force (hereinafter, also merely referred to as a “pressing force”. Furthermore, in this specification, at the contact point, the pressing force means a contact force.) of the coating roller 62 relative to the intermediate transfer belt 32.

In order to supply toner of an amount necessary for preventing the cut surface wear to the blade 63, it is necessary to set each of the contact force of the plate member 61 and the pressing force of the intermediate transfer belt 32 in an appropriate range. Moreover, in the case where toner is excessively supplied to the blade 63, the blade 63 becomes unable to clean the toner, cleaning failure occurs due to the exceeding of the cleaning limit of the blade 63. For this reason, it is preferable that a threshold value of each of the contact force and the pressing force is to be set not only the lower limit but also the upper limit.

The plate member 61 comes in contact with the coating roller 62 by its non-edge portion (by its belly portion). In this case, regardless of the magnitude of the contact force, since the plate member 61 does not scrape toner from the coating roller 62, a range of a settable contact force is wide. Moreover, in the case of a contact by a non-edge portion, without damaging or deteriorating the surface of the coating roller 62 by an edge portion of the plate member 61, even in the case where an error of the contact force arises, a required amount of toner can be coated.

In one embodiment, the contact force of the plate member 61 relative to the coating roller 62 is set preferably to 5 N or more and less than 40 N and is set more preferably to 15 N or more and 30 N or less from a viewpoint of an amount of toner to be supplied as mentioned above. Moreover, the pressing force of the coating roller 62 relative to the intermediate transfer belt 32 is set preferably to 0.5 N or more and less than 40 N and is set more preferably to 10 N or more and less than 20 N. This is because uneven wear is to be suppressed by making an amount of toner supplied to the blade 63 fall within the predetermined range.

(Blade 63)

The blade 63 is a flat plate-shaped member that comes in contact with the intermediate transfer belt 32 and cleans the intermediate transfer belt 32. As shown in FIG. 2, on the downstream side, in the conveyance direction, of the intermediate transfer belt 32 than the coating roller 62, the blade 63 comes in contact with the intermediate transfer belt 32 in the counter direction relative to the conveyance direction of the intermediate transfer belt 32. The toner coated onto the intermediate transfer belt 32 by the coating roller 62 is supplied to the blade 63 with conveyance by the intermediate transfer belt 32. Then, by damming up external additives released from toner by the blade 63 at a contact portion between the blade 63 and the intermediate transfer belt 32, a stillness layer of the external additives is formed. Successively, the stillness layer dams up toner, whereby the intermediate transfer belt 32 is cleaned.

In order to attain a desired cleaning performance for toner, the blade 63 may be configured by, for example, a urethane rubber. The contact force of the blade 63 relative to the intermediate transfer belt 32 may be 15 to 40 N/m, and its contact angle may be 12 to 23 degrees. However, the material of the blade 63 and the contact condition relative to the intermediate transfer belt 32 are not limited to these examples and may be set so as to be able to attain a desired cleaning performance. The blade 63 is disposed to face the support roller 82 across the intermediate transfer belt 32.

A recovery screw 64 is provided at a lower portion of the housing 65. Toner, external additives, paper powder, and the like that have been scraped off by the blade 63 and the coating roller 62, fall below along the inner surface of the housing 65, thereafter, are conveyed by the recovery screw 64 to the back side of the apparatus main body, and are collected into a recovering box (not shown) disposed on the back side.

(Sheet Feed Conveyor 40)

The sheet feed conveyor 40 includes a plurality of sheet feed trays 41 and sheet conveyance paths 42 and 43. In the sheet feed tray 41, a plurality of sheets S is stacked, and a sheet S is fed out one by one from the uppermost of the plurality of sheets S. The sheet feed conveyor 40 includes a plurality of conveyance roller pairs arranged along the sheet conveyance paths 42 and 43 and a drive motor (not shown) to drive the conveyance roller pairs and conveys a sheet S fed out from the sheet feed tray 41 to the transfer position of the secondary transfer unit 33 and the fixing position of the fixing unit 34 disposed on the downstream side of the secondary transfer unit 33.

(Operation Panel 50)

The operation panel 50 includes a touch panel, a ten key, a start button, a stop button, and the like and is used for the input of various settings with regard to the apparatus and the input of each of the display of the state of the apparatus and various instructions, by a user. The kind (brand or a sheet kind) of a sheet S stored in the sheet feed tray 41 can be set by an input through the operation panel 50. The set kind information on the sheet S is memorized in the memory 20.

(Contact Force Changer 70)

On the contact region a2, no support roller is disposed on the inner peripheral surface of the intermediate transfer belt 32. The tension of the intermediate transfer belt 32 on the contact region a2 can be controlled by changing the position of the support roller 81 disposed on the immediately upstream side. The contact force changer 70 includes a drive motor and an actuator and moves the position of the rotation shaft 81A of the support roller 81 disposed nearest to the contact region a2 on the upstream side. In this connection, the contact force changer 70 may be configured to move also the support roller 82 disposed nearest to the contact region a2 on the downstream side.

FIG. 4A and FIG. 4B are illustrations showing an example of the contact force changer 70. In the example shown in FIG. 4A, the contact force changer 70 includes a cam 701 and a drive motor 702. The outer peripheral surface of the cam 701 comes in contact with the outer peripheral surface of the rotation shaft 81A of the support roller 81. By rotating the cam 701 by a predetermined angle by the drive motor 702, the support roller 81 is made to move along a direction (hereinafter, also merely referred to as a “horizontal direction”) perpendicular to the surface of the intermediate transfer belt 32 on the contact region a2. FIG. 4B shows the other example. In the example shown in FIG. 4B, the cam 703 is directly attached to the rotation shaft 81A of the support roller 81. Such a configuration shown in FIG. 4A and FIG. 4B can be employed.

By the contact force changer 70 shown in FIG. 2, FIG. 4A, and FIG. 4B, the tension of the intermediate transfer belt 32 in the vicinity of the second contact region a2 is made to change. In concrete terms, in FIG. 2 and the like, by making the support roller 81 move to the left side, the tension increases, and, by making the support roller 81 move to the right side, the tension decreases.

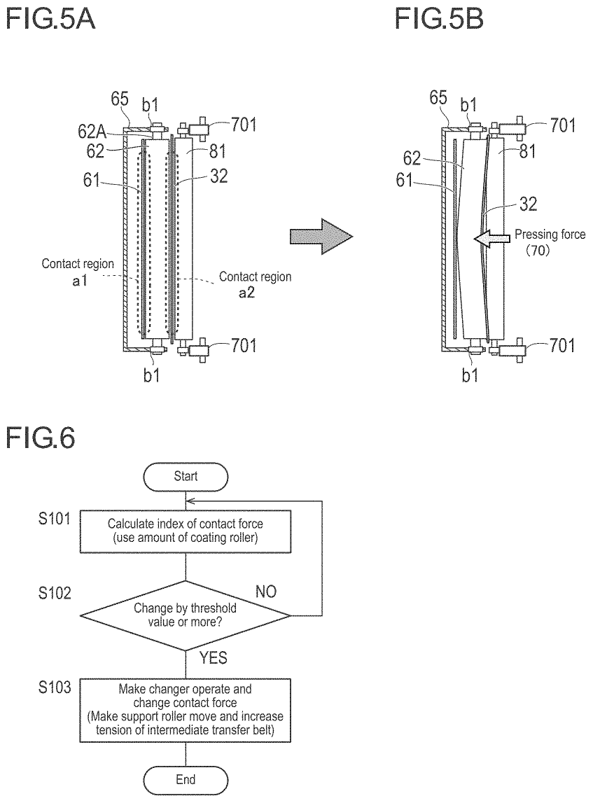

FIG. 5A and FIG. 5B are schematic illustrations for describing an increase in the contact force. FIG. 5A is a schematic top view at an A-A line position in FIG. 4A. By making the support roller 81 move to the left side by making the cam 701 rotate by a predetermined amount by the contact force changer 70, the tension of the intermediate transfer belt 32 increases. In this connection, bearings to support the both ends of the rotation shaft of the support roller 81 are movably inserted in the respective long holes provided on the housing of the intermediate transfer belt unit. With this, the contact force of the coating roller 62 relative to the intermediate transfer belt 32 on the second contact region a2, increases. Moreover, FIG. 5B is an illustration showing a state where the support roller 81 has been moved to the left side. The both ends of the rotation shaft of the coating roller 62 are rotatably supported by the bearings b1 fixedly disposed on the housing 65. As shown in FIG. 5B, due to the increasing of the contact force on the second contact region a2, the coating roller 62 slightly bends. Successively, with this bending, on the first contact region al on the opposite side, the contact force of the coating roller 62 relative to the plate member 61, increases. Namely, by moving the support roller 81 along the horizontal direction, the contact force changer 70 changes the contact force of the plate member 61 relative to the coating roller 62 and the contact force of the coating roller 62 relative to the intermediate transfer belt 32 (hereinafter, these are collectively referred to merely as a “contact force of the coating roller 62”). In this connection, with the bending, the contact force of the coating roller 62 by the plate member 61 becomes uneven between a central portion and an end portion. However, since an image formation region corresponds to the central portion, in the case where the contact force is almost even at the central portion, the contact force is allowed to become uneven at the end portion, and a problem will not occur in an actual condition.

(Inclination Detector 90)

The inclination detector 90 detects the parallelism between the intermediate transfer belt 32 and the coating roller 62. For example, the inclination detector 90 measures the position (position in the horizontal direction) of each of the rotation shaft of the coating roller 62 and the rotation shaft of the support roller 81 by an optical sensor and detects a change in the parallelism between the both rotation shafts. In this connection, the inclination detector 90 may be configured to detect the position of the intermediate transfer belt 32 on the second contact region a2 in place of the position of the rotation shaft of the support roller 81.

(Contact Force Stabilization Processing)

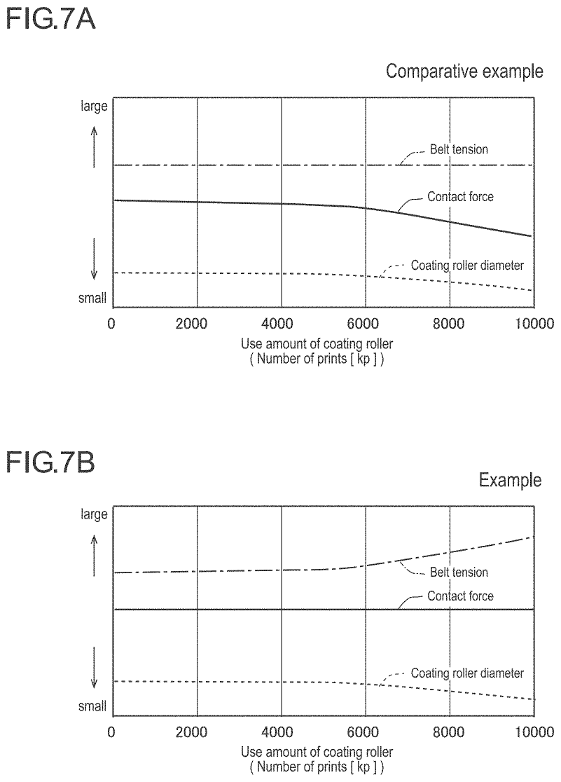

Next, with reference to FIG. 6, FIG. 7A, and FIG. 7B, description is given to contact force stabilization processing that is executed in the image forming apparatus 1 according to the first embodiment and maintains the contact force on the first and second contact regions constant. FIG. 6 is a flowchart showing the contact force stabilization processing.

(Step S101)

The processor 10 calculates an index of a contact force. In concrete terms, the processor 10 estimates an amount of wear of the coating roller 62 as the index. As an estimation method of an amount of wear of the coating roller 62, an amount of wear is calculated from the use history of the coating roller 62 and a wear amount conversion table (estimation formula) memorized in the memory 20. As the use history, the number of prints from the new state of the coating roller 62, use hours, or a running distance in terms of intermediate transfer belt 32 conversion (running distance of the intermediate transfer belt 32) may be used. The use amount of them is calculated sequentially, accumulated as a use history, and memorized in the memory 20. Here, it is assumed that the number of prints from a time when the coating roller 62 has been replaced with a new one, is used.

(Step S102)

In the case where the processor 10 has estimated that an amount of wear estimated from the number of prints and the wear amount conversion table has changed by a predetermined threshold value or more (YES), the processor 10 advances the processing to Step S103.

(Step S103)

The processor 10 controls the contact force changer 70 and changes the position of the rotation shaft of the support roller 81 by an amount of movement according to a change amount of the amount of wear. A conversion formula between an amount of a change amount of an amount of wear and an amount of movement is memorized beforehand in the memory 20.

FIG. 7A is a conceptual diagram showing an endurance change due to the use of the coating roller 62 and a change of the contact force with the endurance change in a comparative example. The horizontal axis represents the use amount of the coating roller 62. The number of 100000 kp corresponds to an exchange cycle of the coating roller 62. The outer diameter of the coating roller 62 is worn out due to use, and the outer diameter becomes small. Moreover, in connection with this, the contact force of the coating roller 62 relative to the intermediate transfer belt 32 (or the contact force of the plate member 61 relative to the coating roller 62) also lowers. In the comparative example, since the belt tension is not controlled, the belt tension is constant.

FIG. 7B is a conceptual diagram showing an endurance change due to use of the coating roller 62 and a change of the contact force with the endurance change in the first embodiment. In the first embodiment, with the control as shown in FIG. 6, by changing the position of the rotation shaft of the support roller 81 by the contact force changer 70, the tension of the intermediate transfer belt 32 is controlled. That is, so as to supplement the reduced contact force, the belt tension is caused to increase correspondingly to the amount of use of the coating roller 62 as shown in FIG. 7B. With this, the contact force of the coating roller 62 is maintained constant over the whole range (whole life) of an exchange cycle.

In this way, the image forming apparatus 1 according to the first embodiment includes the contact force changer 70 that changes the contact force of the plate member 61 relative to the coating roller 62 and the contact force of the coating roller 62 relative to the intermediate transfer belt 32, and controls the contact force changer 70 according to a change of the index with regard to the contact force of the coating roller 62. By doing in this way, even in the case where the coating roller 62 has been worn out due to long-term use, it is possible to maintain the contact force of the coating roller 62 constant. With this, an amount of toner to be supplied to the edge of the blade 63 can be maintained constant over a long period of time. With this, by supplying toner to the blade 63 stably over a long period of time, the cut surface wear of the blade 63 can be prevented.

(Second Embodiment)

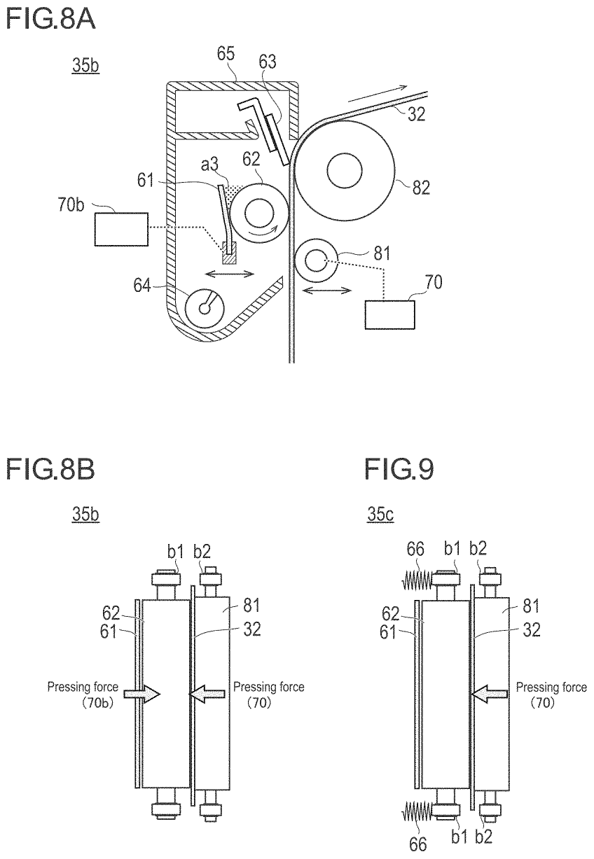

FIG. 8A and FIG. 8B are illustrations showing a configuration of the cleaning unit 35b in the second embodiment. In this connection, although FIG. 8B is a schematic top view corresponding to FIG. 4A and FIG. 4B, in FIG. 8B, the scales in the vertical and horizontal directions are changed for convenience of description (dimension in the direction of a rotation shaft is reduced). In the first embodiment, although the position of the support roller 81 disposed on the inner peripheral surface side of the intermediate transfer belt 32 has been changed, in the second embodiment, as described below, further, by changing the position of the plate member 61, the contact force of a coating roller is changed.

The cleaning unit 35b in the second embodiment includes a first contact force changer 70 and a second contact force changer 70b. The first contact force changer 70 is the same as that in the first embodiment, and the first contact force changer 70 changes the tension of the intermediate transfer belt 32 by changing the position of the support roller 81. With this, the contact force of the coating roller 62 is changed. The second contact force changer 70b changes the position of the plate member 61. The second contact force changer 70b moves a holding member 61A holding the plate member 61 along a direction (horizontal direction) vertical to the surface of the intermediate transfer belt 32. The second contact force changer 70b includes a drive motor and an actuator and moves the position of the plate member 61. With this, the contact force of the plate member 61 relative to the coating roller 62 is changed.

In this way, in the second embodiment, as shown in FIG. 8B, by changing the pressing force from the both sides of the coating roller 62 by the contact force changers 70 and 70b, the increasing or decreasing of the contact force can be performed stably. With this, since the contact force can be maintained constant more accurately, an amount of toner to be supplied to the edge of the blade 63 can be maintained constant over a long period of time. Eventually, by supplying toner to the blade 63 stably over a long period of time, the cut surface wear of the blade 63 can be prevented.

(Third Embodiment)

FIG. 9 is a drawing showing a configuration of a cleaning unit 35c in the third embodiment. FIG. 9 is a schematic top view corresponding to FIG. 8B. In the third embodiment, similarly to the first embodiment, the position of the support roller 81 is changed by the contact force changer 70. In the third embodiment, the end positions of the coating roller 62 are configured to be changeable. In concrete terms, the both ends of the rotation shaft of the coating roller 62 are rotatably supported by the bearings b1. The bearings b1 inserted in the respective long holes (not shown) that are opened in the housing 65 are urged toward the intermediate transfer belt 32 with a predetermined pressing force by urging members 66, such as springs. The longitudinal direction of each of the long holes is stretched to exist in the horizontal direction, and the bearings b1 (and the coating roller 62) are movable in the horizontal direction. In the first embodiment, as shown in FIG. 5B, the pressing force at the central portion is higher than the pressing force at an end, and the distribution of the pressing force becomes uneven in the direction of a rotation shaft. On the other hand, in this way, in the third embodiment, since the whole coating roller 62 is configured to move, the unevenness of the pressing force in the direction of the rotation shaft is difficult to occur. That is, the contact force of the coating roller 62 can be made more even. With this, similarly to the first embodiment, by supplying toner to the blade 63 stably over a long period of time, the cut surface wear of the blade 63 can be prevented.

(Fourth Embodiment)

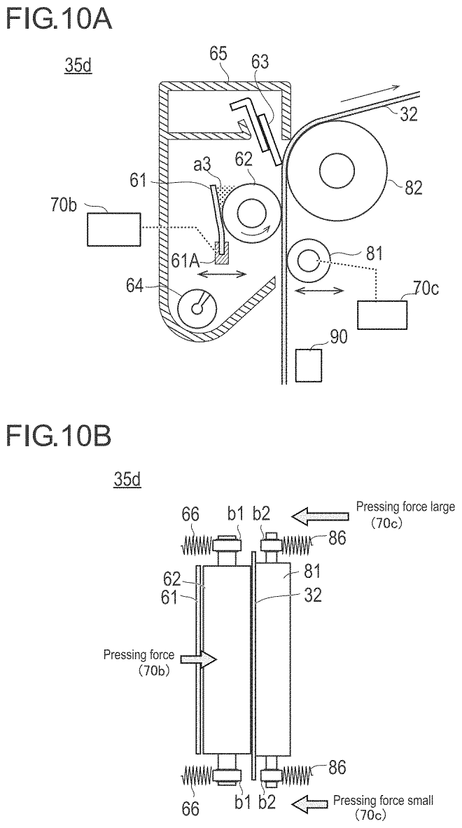

FIG. 10A and FIG. 10B are illustrations showing a configuration of a cleaning unit 35d of the image forming apparatus 1 in the fourth embodiment. FIG. 10A and FIG. 10B correspond to FIG. 8A and FIG. 8B respectively. In the fourth embodiment, by the inclination detector 90 of the image forming apparatus 1, the position of each of the rotation shaft of the coating roller 62 and the rotation shaft of the support roller 81 is measured, and a change in the parallelism between the both rotation shafts is detected. Moreover, as shown in FIG. 10B, the both ends of the rotation shaft of the support roller 81 are rotatably supported by the bearings b2. Moreover, the bearings b2 inserted in the respective long holes (not shown) opened in the housing that holds the intermediate transfer belt 32, the support roller 81 and 82, and the like, are urged by the respective urging members 86, such as a spring, towards the intermediate transfer belt 32 with a predetermined pressing force. The longitudinal direction of each of the long holes is extended to exist in the horizontal direction, and the bearings b2 (and the support roller 81) are movable in the horizontal direction. Moreover, each of the both ends of the support roller 81 is pressed by the contact force changer 70c. The pressing force for each of the both ends of the shaft can be changed individually.

A housing (not shown) that holds the intermediate transfer belt 32 and a plurality of support rollers, such as the support roller 81 and 82 and the housing 65 that holds each constituent part such as the plate member 61 and the coating roller 62 of the cleaning unit 35 are separate housings. Therefore, there is a possibility that a group of the plate member 61 and the coating roller 62 and a group of the intermediate transfer belt 32 and the support roller 81 are not parallel to each other. In the fourth embodiment, the inclination detector 90 detects the position of each of the rotation shaft of the coating roller 62 and the rotation shaft of the support roller 81. The inclination detectors 90 are disposed on each of the both end sides in the direction of the rotation shaft. On the basis of the detection result of the inclination detectors 90, the processor 10 determines the parallelism between the coating roller 62 and the support roller 81.

The processor 10 controls the contact force changer 70c according to the determined parallelism. In the case where the parallelism has deviated, the contact force changer 70c makes the pressing forces given to the rotation shaft of the support roller 81 different so as to cancel the deviation. For example, as shown in FIG. 10B, so as to cancel the deviation of the parallelism, the pressing force at one end portion (back side) is made large, and the pressing force of the other end portion (front side) is made small. With this, the similar effect to that in the first embodiment is acquired, and, in addition, the pressing force can be made even in the axial direction. Accordingly, toner supply to the blade edge in the axial direction can be performed stably, and the cut surface wear of the blade 63 can be prevented.

(Fifth Embodiment)

As mentioned above, the contact force of the plate member 61 relative to the coating roller 62 is set to 5 N or more and less than 40 N. For this reason, when the rotation of the coating roller 62 is made to start, the torque at the time of starting a drive motor becomes large. In order to avoid this phenomenon, in the fifth embodiment, as described in below, at the time of starting, only for a predetermined time, the tension of the intermediate transfer belt 32 is made weak, and the contact force of the coating roller 62 relative to the intermediate transfer belt 32 is made weak, thereby making the torque of the drive motor small.

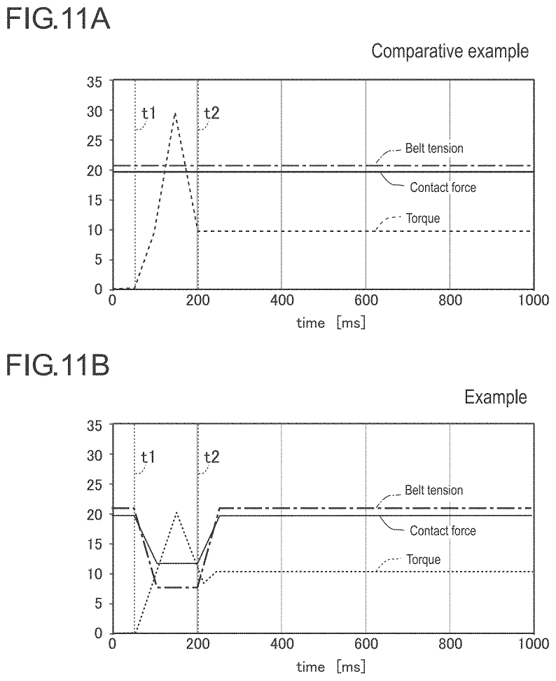

FIG. 11A is a time chart showing the transition of torque and the like at the time of starting in a comparative example. FIG. 11A shows the transition of each of the tension of the intermediate transfer belt 32, the contact force of the coating roller 62 relative to the intermediate transfer belt 32, and the torque of the drive motor of the coating roller 62. At time t1, the drive motor of the coating roller 62 is started. In connection with this, in a period of time from the time t1 to the time t2, an increase in the torque at the time of starting is seen. After the time t2, the torque is stable.

FIG. 11B is a time chart showing the transition of the torque and the like at the time of starting in the fifth embodiment. In an example shown in FIG. 11B, the tension of the intermediate transfer belt 32 is lowered only for a period from time t1 to time t2 (several tens of milliseconds to several hundreds of milliseconds). In concrete terms, by controlling the contact force changer 70, the processor 10 moves the position of the support roller 81 in the retraction direction (right side in FIG. 2) and lowers the tension of the intermediate transfer belt 32 in the contact region a2. After the torque has stabilized (after the time t2), the position is returned to the original position. With this, in the example in FIG. 11B, as compared with FIG. 11A, the rise of the torque of the drive motor of the coating roller 62 can be reduced. By controlling in this way, the upper limit torque of the drive motor of the coating roller 62 can be lowered. In the comparative example, in order to suppress out of adjustment at the time of starting, it is necessary to use a high large rated torque motor. However, in the example, there is an advantage that a cheap motor with low torque and small size can be employed. In this connection, in the fifth embodiment, the position of the support roller 81 has been moved. However, in place of the above operation, the position of the plate member 61 is moved to the retracting side by the contact force changer 70b (refer to FIG. 8A), whereby the starting torque may be intended so as to be reduced.

The configuration of each of the cleaning unit 35 (35b to 35d) and the image forming apparatus 1 including these cleaning units has been described in the above for describing the main configuration to describe the features of the above-mentioned embodiments. Accordingly, without being limited to the above-mentioned configuration, in the scope of patent claims, various modifications can be made. Moreover, the configurations included in general image forming apparatuses are not to be excluded.

For example, in the above-mentioned embodiments, the cleaning unit is configured to clean the intermediate transfer belt 32 as an image carrier. However, without being limited to this configuration, the cleaning unit is configured to clean a photoconductor drum as an image carrier. In concrete terms, the configuration of the cleaning unit in the above-mentioned first to fifth embodiments may be applied to the cleaning unit 316 of the image former 31.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
a cleaning unit that includes;
a cleaning blade that comes in contact with an image carrier and cleans the image carrier,
a coating roller that comes in contact with the image carrier on an upstream side, in a conveyance direction, of the image carrier than the cleaning blade and coats toner onto the image carrier, and
a plate member that comes in contact with the coating roller and coats the toner onto the coating roller;
a contact force changer that changes a contact force of the plate member relative to the coating roller and/or a contact force of the coating roller relative to the image carrier; and
a processor that controls the contact force changer correspondingly to a change of an index with regard to the contact force of the coating roller.

2. The image forming apparatus according to claim 1, wherein the processor estimates, as the index, an amount of wear of the coating roller and controls the contact force changer correspondingly to the estimated amount of wear.

3. The image forming apparatus according to claim 2, wherein the processor estimates the amount of wear correspondingly to a use history of the coating roller.

4. The image forming apparatus according to claim 1, wherein the image carrier is an endless belt stretched by a plurality of support rollers, and
the contact force changer changes tension of the image carrier.

5. The image forming apparatus according to claim 4, wherein the contact force changer changes a position of at least one of the support rollers disposed on an inner peripheral surface side of the image carrier.

6. The image forming apparatus according to claim 4, wherein a position of a rotation shaft of the coating roller is fixed, and the contact force changer changes a contact force of the plate member relative to the coating roller and/or a contact force of the coating roller relative to the image carrier by changing tension of the image carrier.

7. The image forming apparatus according to claim 4, wherein a position of a rotation shaft of the coating roller is fixed, and the contact force changer changes a contact force of the plate member relative to the coating roller and a contact force of the coating roller relative to the image carrier by changing a position of the plate member and tension of the image carrier.

8. The image forming apparatus according to claim 4, wherein a position of a rotation shaft of the coating roller is changeable, and the contact force changer changes a contact force of the plate member relative to the coating roller and/or a contact force of the coating roller relative to the image carrier by changing tension of the image carrier.

9. The image forming apparatus according to claim 5, wherein correspondingly to parallelism between a rotation shaft of the coating roller and the image carrier,
the contact force changer makes pressing forces at both ends of the support roller onto the image carrier differ or makes amounts of movement at both ends of the support roller differ.

10. The image forming apparatus according to claim 5, wherein the processor controls, at a time of starting rotation of the coating roller, the contact force changer so as to make tension of the image carrier small by making the support roller move.

11. The image forming apparatus according to claim 1, wherein the contact force changer changes a contact force of the plate member relative to the coating roller by changing a position of the plate member.
